(19) United States
(12) Patent Application Publication
(10) Pub. No.: US 2012/0170816 A1
(43) Pub. Date: Jul. 5, 2012

(54) METHOD FOR CREATING BIOMETRIC INFORMATION FOR USE WITH BIOMETRIC AUTHENTICATION DEVICE, AUTHENTICATION METHOD, AND AUTHENTICATION DEVICE

(75) Inventor: Mitsuharu Tsukiori, Tokyo (JP)

(73) Assignee: HITACHI SOLUTIONS, LTD., Tokyo (JP)

(21) Appl. No.: 13/496,336

(22) PCT Filed: Sep. 13, 2010
(86) PCT No.: PCT/JP2010/005568

§ 371 Date: Mar. 15, 2012

(30) Foreign Application Priority Data
Sep. 16, 2009 (JP) 2009-214019

(51) Int. Cl. G06K 9/34

(52) U.S. Cl. 382/115

(57) ABSTRACT

The device includes first means for splitting a biometric pattern image into a plurality of regions, assigning index numbers to the respective split-pattern images, and storing them in a split-image table; second means for splitting a newly read biometric pattern image into a plurality of regions, comparing each of the split-pattern images with the split-pattern images stored in the split-image table, acquiring or assigning, depending on if the split-image table is determined to have stored therein a similar split-pattern image, an index number to the relevant split-pattern image of the newly read pattern image, and storing them in the split-image table; and third means for creating, as biometric information that represents a feature of the newly read biometric pattern, an index number list composed of the index number.

### TECHNICAL FIELD

The present invention relates to a method for creating biometric information for use with a biometric authentication device, and an authentication method. In particular, the invention relates to a method for reducing the volume of biometric information.

### BACKGROUND ART

In recent years, individual authentication devices that use vein patterns, namely, individual authentication devices adapted to irradiate a vein portion with near infrared rays, capture an image from the resulting transmitted light or reflected light, and extract a vein pattern from the captured image data for use in authentication of individuals have been spreading.

The vein pattern extracted with such an individual authentication device is registered as biometric registration information in memory of the individual authentication device or in an IC card carried by an individual. In authentication of an individual, a vein pattern extracted from the individual is matched to the registered vein pattern so that the authenticity of the individual is determined.

Authentication of individuals is performed by, for example, writing biometric registration information to an IC card in advance, and presenting the IC card to an authentication device so that the device reads a vein pattern, which is the biometric information of the individual, and determines the authenticity of the person who presented the IC.
Patent Literature 1 below discloses the conventional related art.

### CITATION LIST

### Patent Literature

{PTL 1}
JP Patent Publication No. 2007-133623

In such a device, if the size of a writable storage area in an IC card is smaller than that of the biometric registration information, it would be impossible to implement the system. Further, as a case can be considered in which one intends to register a plurality of pieces of biometric information, the volume of biometric information to be registered is still desirably small.

### SUMMARY OF INVENTION

### Technical Problem

In order to reduce the volume of biometric information extracted from a living body such as a vein pattern, for example, a method for reducing the image size is known. However, as such image data should basically be used for individual authentication, its volume should be more than a certain level to represent a biometric feature.

Conventionally, there has been no practical methods for reducing the volume of biometric information extracted from a living body.

Accordingly, it is an object of the present invention to provide a method and device for creating biometric information, with which the volume of image data as biometric information can be reduced without loss of the characteristic portions of individuals.

It is another object of the present invention to provide a method and device for performing individual authentication using the thus created biometric information.

### Solution to Problem

In order to solve the aforementioned problem, a method for creating biometric information of the present invention includes the following steps executed by a biometric information creation device: a first step of reading a pattern image of a living body and splitting the pattern image into a plurality of regions on a two-dimensional plane; a second step of assigning index numbers to the respective split-pattern images and storing in a split-image table the split-pattern images with the index numbers assigned thereto; a third step of splitting a pattern image newly read from a living body into a plurality of regions on a two-dimensional plane and comparing each of the split-pattern images with the split-pattern images stored in the split-image table; a fourth step of acquiring, if the split-image table is determined to have stored therein a split-pattern image that is similar to one of the split-pattern images of the newly read pattern image as a result of the comparison between the split-pattern images, the index number assigned to the similar split-pattern image; a fifth step of assigning, if the split-image table is not determined to have stored therein a similar split-pattern image, an index number to the relevant split-pattern image of the newly read pattern image, and storing in the split-image table the relevant split-pattern image with the index number assigned thereto; and a sixth step of creating, as biometric information that represents a feature of the newly read pattern image of the living body, an index number list composed of the index number acquired in the fourth step and the index number of the split-pattern image stored in the fifth step, and registering the index number list in recording means such as an IC card.

A biometric information creation device according to the present invention includes: first means for reading a pattern image of a living body, splitting the pattern image into a plurality of regions on a two-dimensional plane, assigning index numbers to the respective split-pattern images, and storing in a split-image table the split-pattern images with the index numbers assigned thereto; second means for splitting a pattern image newly read from a living body into a plurality of regions on a two-dimensional plane, comparing each of the split-pattern images with the split-pattern images stored in the split-image table, acquiring, if the split-image table is determined to have stored therein a split pattern-image that is similar to one of the split-pattern images of the newly read pattern image as a result of the comparison, the index number assigned to the similar split-pattern image, assigning, if the split-image table is not determined to have stored therein a similar split-pattern image, an index number to the relevant split-pattern image of the newly read pattern image, and storing in the split-image table the relevant split-pattern image with the index number assigned thereto; and third means for creating, as biometric information that represents a feature of the newly read pattern image of the living body, an index number list composed of the index number acquired when the split-image table has stored therein a similar split-pattern image and the index number assigned to the relevant split-pattern image of the newly read pattern image when the split-image table does not have stored therein a similar split-pattern image, and registering the index number list in recording means such as an IC card.

An individual authentication method using the biometric information according to the present invention includes: a first step of splitting a pattern image read from a living body into a plurality of regions on a two-dimensional plane, assigning index numbers to the respective split-pattern images, storing in a split-image table the split-pattern images with the index numbers assigned thereto, splitting, each time a new pattern image is read from a living body, the read pattern image of the living body into a plurality of regions on a two-dimensional plane, and assigning, if the split-image table is not determined to have stored therein a split-pattern image that is similar to one of the split-pattern images of the newly read pattern image, an index number to the relevant split-pattern image of the newly read pattern image, and storing in the split-image table the relevant split-pattern image with the index number assigned thereto; a second step of reading an index number list of split-pattern images in the split-image table that is recorded in a recording medium presented by an individual to be authenticated, acquiring from the split-image table a plurality of split-pattern images indicated by the index number list, and combining the acquired split-pattern images into a single composite pattern image; and a third step of reading a biometric pattern image of the individual to be authenticated, matching the pattern image to the composite pattern image through pattern matching, and if the match succeeds, authenticating the individual who has presented the recording medium.

The index number list read from the recording medium in the second step is obtained by recording an index number list in the recording medium in advance with a biometric information creation device, the index number list being composed the index number, which is acquired when the split-image table has stored therein a split-pattern image that is similar to one of the split-pattern images obtained by splitting the biometric pattern image acquired from the individual to be authenticated into a plurality of regions on a two-dimensional plane, and the index number of the split-pattern image newly stored in the split-image table.

An individual authentication device using the biometric information according to the present invention includes: a split-image table adapted to have stored therein split-pattern images obtained by splitting a pattern image read from a living body into a plurality of regions on a two dimensional plane and index numbers assigned thereto, and adapted to have stored therein, each time a new pattern image is read from a living body and is split into a plurality of regions on a two-dimensional plane, if the split-image table does not have stored therein a split-pattern image that is similar to one of the split-pattern images of the newly read pattern image, the relevant split-pattern image of the newly read pattern image and an index number assigned thereto; means for reading an index number list of split-pattern images in the split-image table that is recorded in a recording medium presented by an individual to be authenticated, acquiring from the split-image table a plurality of split-pattern images indicated by the index number list, and combining the acquired split-pattern images into a single composite pattern image; and means for reading a biometric pattern image of the individual to be authenticated, matching the pattern image to the composite pattern image through pattern matching, and, if the match succeeds, authenticating the individual who has presented the recording medium.

The index number list read from the recording medium presented by the individual to be authenticated is obtained by recording an index number list in the recording medium in advance with a biometric information creation device, the index number list being composed the index number, which is acquired when the split-image table has stored therein a split-pattern image that is similar to one of the split-pattern images obtained by splitting the biometric pattern image acquired from the individual to be authenticated into a plurality of regions on a two-dimensional plane, and the index number of the split-pattern image newly stored in the split-image table.

### Advantageous Effects of Invention

According to the present invention, the following advantageous effects are provided.

(1) Image data is not registered as biometric information in a storage medium such as an IC card, but a list of indices of “split-pattern images” that are registered in the device is stored in the storage medium. Thus, the volume of data can be reduced than when image data is stored.

(2) When image data is registered as biometric information, it is concerned that if the data leaks to a third party, he/she may create a counterfeit biometric image from the image data. However, as the biometric information of the present invention does not include such image information, it would be impossible to create counterfeit biometric information; thus, safety is ensured.

### BRIEF DESCRIPTION OF DRAWINGS

FIG. 1 is a block configuration diagram showing an embodiment of a biometric information creation device in accordance with the present invention.

FIGS. 2A to 2F are diagrams showing a split-image table and a process for creating registration information.

FIGS. 3A and 3B are diagrams showing a split-image table and a process for creating registration information.

FIGS. 4A and 4B are diagrams showing a split-image table and a process for creating registration information.

FIGS. 5A and 5B are diagrams showing a split-image table and a process for creating registration information.

FIGS. 6A and 6B are diagrams showing examples of created biometric registration information.

FIG. 7 is a block configuration diagram showing an embodiment of a biometric authentication device in accordance with the present invention.

FIG. 8 is a diagram showing a process for creating a composite image from biometric registration information.

FIG. 9 is a flowchart for creating biometric registration information.

FIG. 10 is a flowchart for performing authentication with biometric registration information.

### DESCRIPTION OF EMBODIMENTS

Hereinafter, an embodiment of a biometric information creation device to which the present invention is applied will be described.

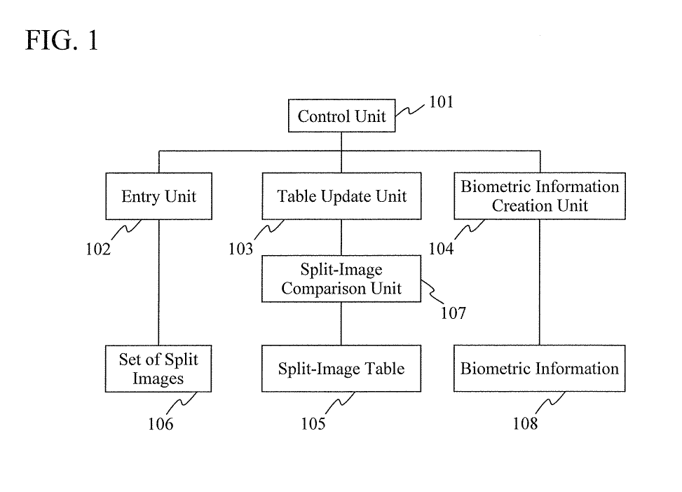

FIG. 1 is a configuration diagram showing a case in which biometric information is created with the present invention. Upon instruction from a controller 101, an entry unit 102 enters a biometric pattern image and splits it into a predetermined plurality of regions on a two-dimensional plane to create a set of split images 106.

A table update unit 103, upon instruction from the controller 101, matches each split image included in the set of split images 106 to all of split images registered in a split-image table 105, using a split-image comparison unit 107.

The split-image comparison unit 107 matches a specified split image to all of the split images in the split-image table 105. Exemplary matching methods include a method that involves tracing all pixels, counting the number of pixels N that are located in the same position and have the same value, determining the ratio of the number of pixels N to the total number of pixels A, and evaluating images with a ratio that is closer to “1” as being “similar.” However, any methods can be used as long as the degree of similarity can be quantified. Herein, values of “0 to 1” are used to represent the degree of similarity, and a value that is closer to “1” is regarded as being more similar.

Matching to all of the split images in the split-image table 105 is performed, whereby a split image with the highest degree of similarity is selected, and then the highest degree of similarity is compared with a threshold T. The threshold T is used to determine “if images are similar.” If the degree of similarity is higher than the threshold T, the images are determined to be “similar,” so that an index of the split image selected from the split-image table 105 is stored in a biometric information storage area 108.

If the degree of similarity is lower than the threshold T, it is determined that “no similar split images exist.” Thus, the specified split image is added to the split-image table 105, and an index thereof is stored in the biometric information storage area 108.

A biometric information creation unit 104 reads a list of indices stored in the biometric information storage area 108, and outputs the list as the biometric registration information to a recording medium such as an IC card.

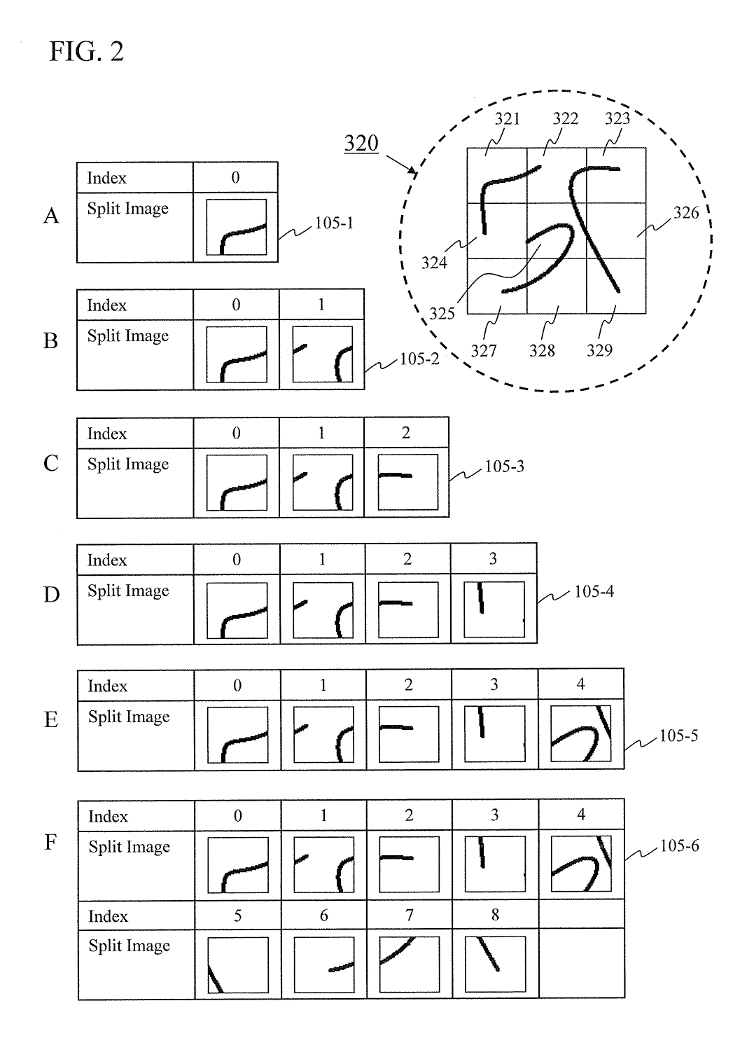

The operation of the split-image table 105 and the creation of the biometric registration information will be described with reference to FIG. 2A to FIG. 6B.

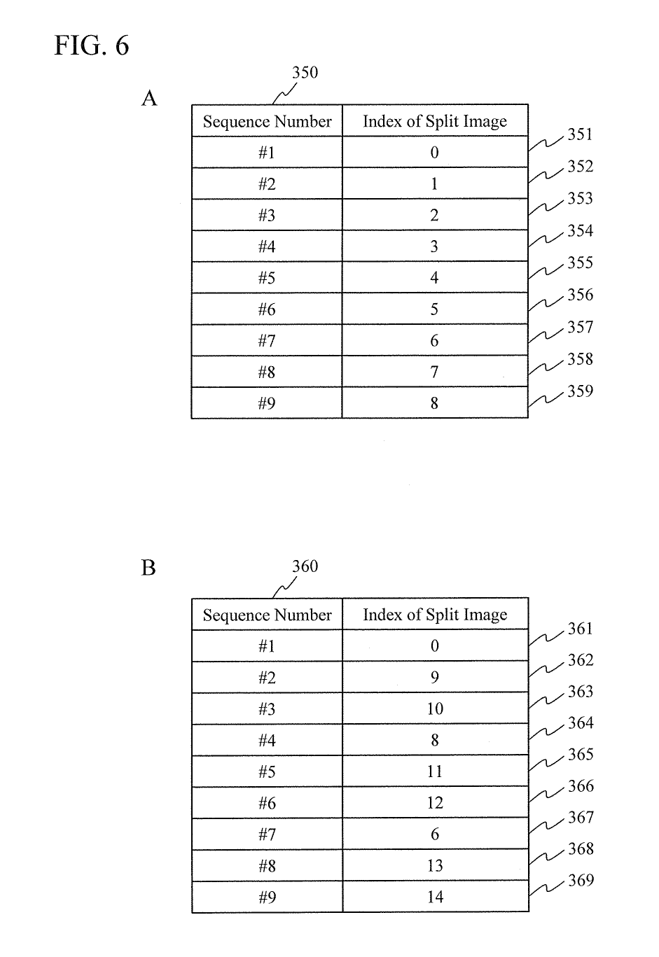

Split-image tables 105-1 to 105-12 shown in FIG. 2A to FIG. 5B show the states in which split images are added by processes. Although the sequence numbers of biometric registration information 350 and 360 shown in FIGS. 6A and 6B are provided for descriptive purposes, the actual registration information does not include such numbers.

First, a biometric pattern image 320 shown in FIG. 2 is read from the entry unit 102.

Then, the biometric pattern image 320 is split into a plurality of regions on a two-dimensional plane. For example, it is split into 3×3 regions as shown. The resulting images in the 3×3 split regions shall be designated as split images 321 to 329.

First, the split-image comparison unit 107 retrieves the split image 321 from the set of split images 106, and compares it with each split image in the split-image table 105. The split-image table 105 is initially in an empty state. Thus, no similar split images exist as a result of the initial image matching. Accordingly, the split-image comparison unit 107 adds and registers the split image 321 to/in the split-image table 105. Accordingly, the split image 321 is newly registered in the split-image table 105 with an index number “0” assigned thereto. The split-image table 105 in such a state is shown as a split-image table 105-1 in FIG. 2A. In addition, “0” is registered as an index of a split image with a sequence number#1 of the biometric registration information 350 registered in the biometric information storage area 108, as shown in FIG. 6A.

Next, the split image 322 is retrieved from the set of split images 106 and is compared with the split image with the index number “0” in the split-image table 105-1. In this case, the split images are not determined to be similar to each other, and thus the split image 322 is added to the split-image table 105, whereby a split-image table 105-2 results as shown in FIG. 2B. At this time, the index of the split image 322 is “1.” Thus, “1” is registered in a second entry 352 of the biometric registration information 350.

Thereafter, the split-image comparison unit 107 matches the split images 323, 324, 325, 326,327, 328, and 329 to the split images registered in the split-image table 105 in a similar way, and updates the split-image table 105 in accordance with results of the similarity determination.

In the example shown herein, no similar split images are determined to exist as a result of the matching performed between the split images 323, 324, 325, 326, 327, 328, and 329 and the split images registered in the split-image table 105. Thus, all of the split images 323, 324, 325, 326, 327, 328, and 329 are registered in the split-image table 105 with index numbers 2 to 8 assigned to the respective split images as shown in FIGS. 2C to 2F.

The split-image comparison unit 107, upon completion of the matching of all split images, records on and outputs to a recording medium such as an IC card the biometric registration information 350 registered in the biometric information storage area 108, that is, the biometric registration information 350 having a list of index numbers of the split-image tables 150 as shown in FIG. 6A.

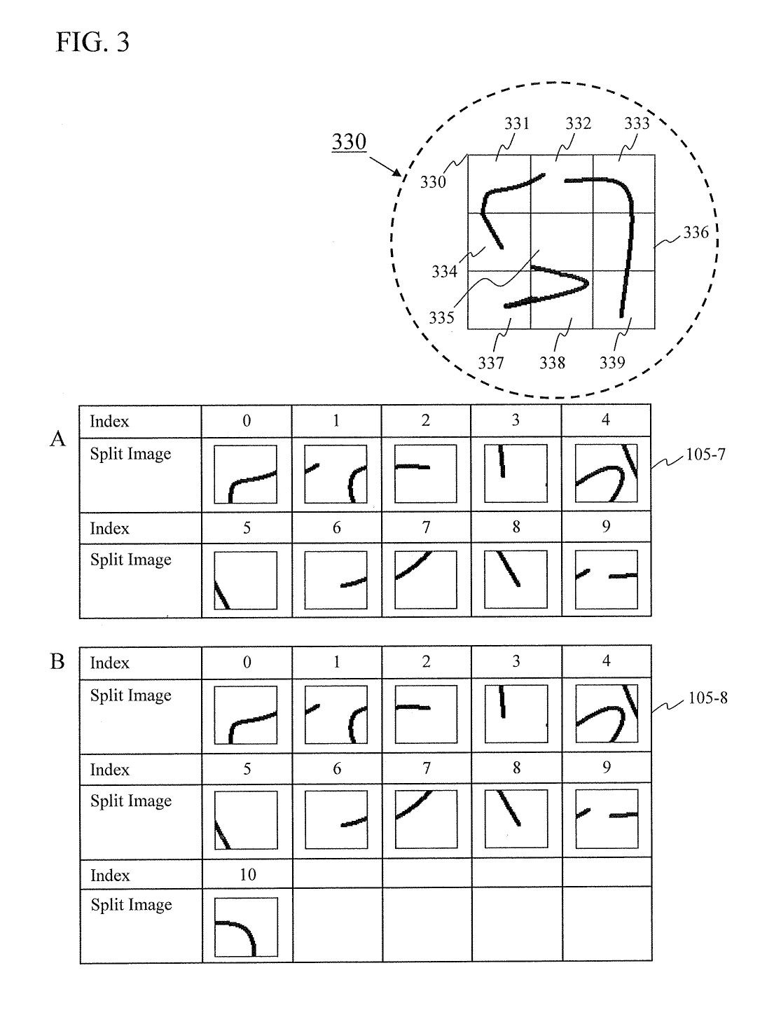

When the split-image table 105 is in a state of FIG. 2F and a new biometric pattern image 330 such as the one shown in FIG. 3 is entered, the split-image comparison unit 107 compares split images 331 to 339 of the biometric pattern image 330 with the split images registered in the split-image table 105.

First, the split-image comparison unit 107 sequentially compares the split image 331 with all of the split images included in a split-image table 105. Consequently, the split image 331 is determined to be similar to the split image with the index number “0.” As a result of such comparison, the split image 331 is not added to or registered in the split-image table 105. At this time, as the index number of the split image 331 is “0,” “0” is registered in a first entry 361 of the biometric registration information 360 shown in FIG. 6B.

Likewise, the split-image comparison unit 107 compares the other split images with the split images registered in the split-image table 105.

The split images 332 and 333 have no similar split images registered in advance. Thus, the split images 332 and 333 are added with indices “9” and “10,” respectively, as shown in the split-image tables 105-7 and 105-8 of FIGS. 3A and 3B. The index numbers of the split images 332 and 333 are registered in entries 362 and 363 of the biometric registration information 360 shown in FIG. 6B.

The split image 334 is similar to the split image corresponding to the index number “8” in the split-image table 105. Thus, the split image 334 is not added. At this time, the index number “8” in the split-image table 105 is registered for the split image 334 in a fourth entry 364 of the biometric registration information 360.

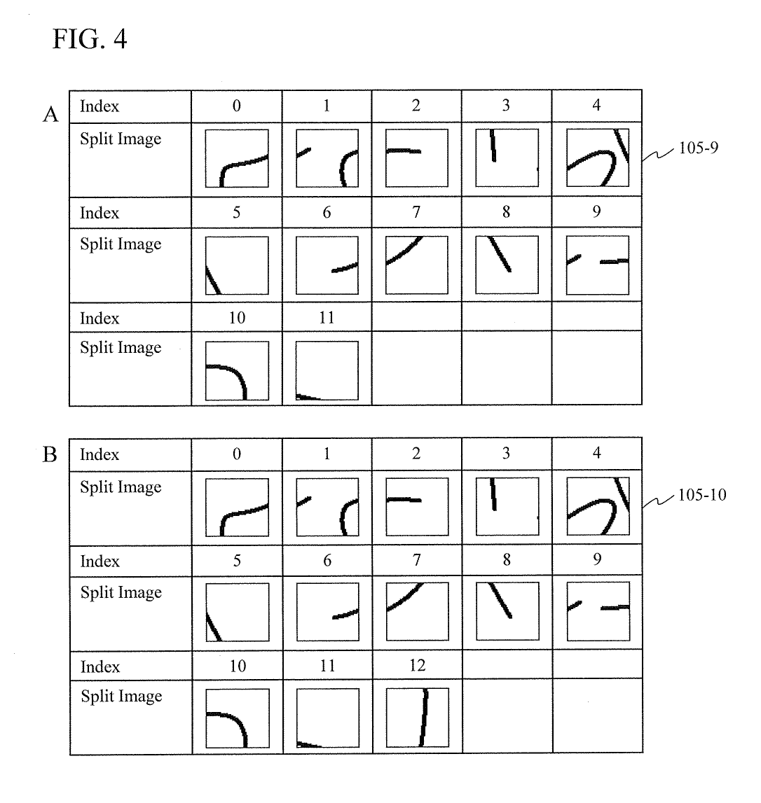

The split images 335 and 336 have no similar split images registered in advance in the split-image table 105. Thus, the split images 335 and 336 are added as entries corresponding to indices “11” and “12” as shown in the split-image tables 105-9 and 105-10 of FIG. 4A and FIG. 4B.

The indices of the split images 335 and 336 are registered in entries 365 and 366 of the biometric registration information 360 shown in FIG. 6B.

Next, as the split image 337 is similar to the split image corresponding to the index “6” in the split-image table 105, the split image 337 is not added. At this time, “6” is designated as the index of the split image 337 in the split-image table, and it is registered in a seventh entry 367 of the registration information 360.

The split images 338 and 339 have no similar split images registered in advance in the split-image table 105. Thus, the split images 338 and 339 are added and registered in entries corresponding to index numbers “13” and “14,” respectively, in the split-image tables 105-11 and 105-12. The index numbers of the split images 338 and 339 are registered in entries 368 and 369 of the registration information 360.

As described above, the biometric registration information 350 shown in FIG. 6A is created from the biometric pattern image 320, and the biometric registration information 360 shown in FIG. 6B is created from the biometric image pattern 330.

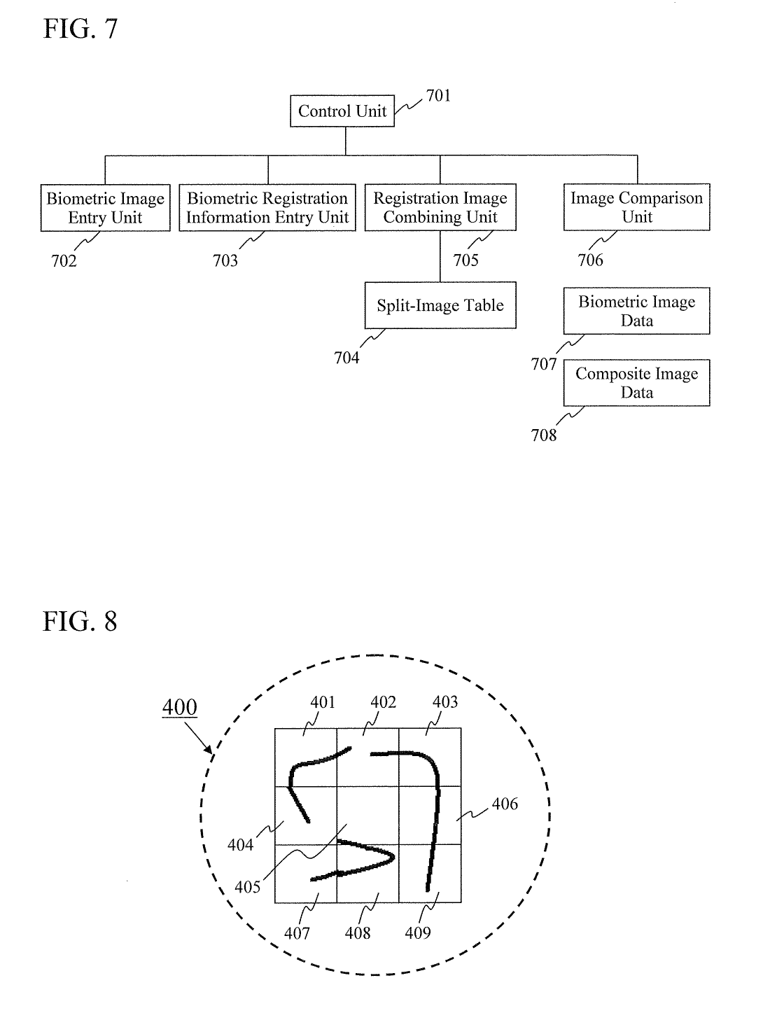

FIG. 7 is a block configuration diagram showing a case in which authentication is performed with the biometric information created with the present invention. Upon instruction from a controller 701, a biometric image entry unit 702 enters a biometric pattern image (e.g., a vein pattern) to be authenticated, and creates biometric image data 707.

A biometric registration information entry unit 703 is constructed from a biometric information creation device with a configuration such as the one shown in FIG. 1 of the present invention, and is configured to read biometric registration information recorded in a recording medium such as an IC card and provide the information to a registration image combining unit 705.

The registration image combining unit 705 sequentially retrieves the indices of split images from the biometric registration information composed of a list of the index numbers of split images created with a biometric information creation device with a configuration such as the one shown in FIG. 1, retrieves a split image corresponding to the relevant index number with reference to a split-image table 704, and embeds it into a corresponding position of composite image data 708.

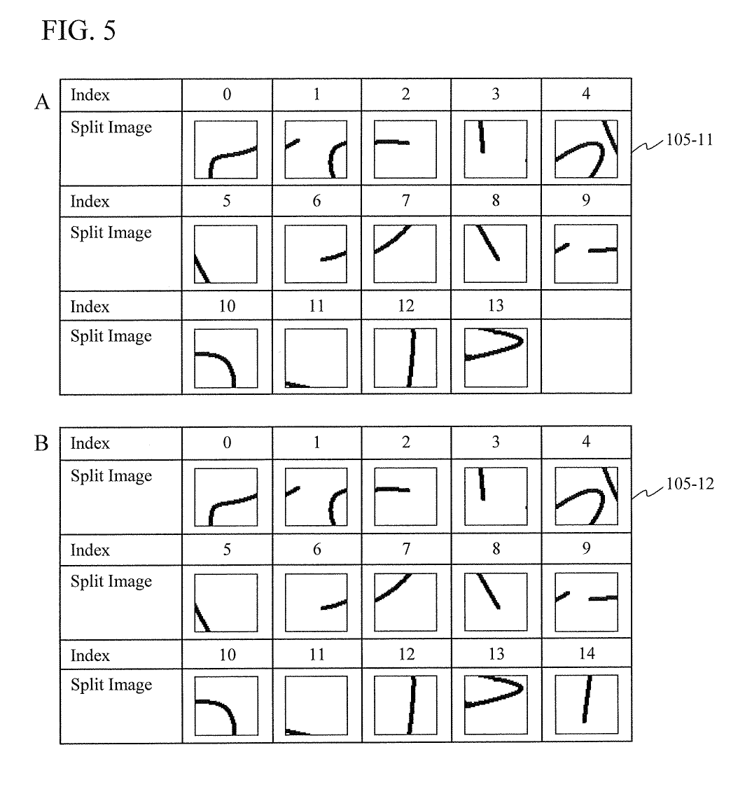

The process for creating the composite image data 708 will now be described. Herein, an example is described in which composite image data 400 shown in FIG. 8 is created using the biometric registration information 360 of FIG. 6b and the split-image table 105-12 of FIG. 5B.

In the biometric registration information 360 of FIG. 6B, index numbers 0, 9, 10, 8, 11, 12,6, 13, and 14 are registered in nine entries.

Herein, the index of a split image that should be embedded into a first split region 401 of the composite image data 400 is found to be “0” from the entry 361 of the registration information 360. Thus, a split image corresponding to the index “0” is retrieved from the split-image table 105-12 and is embedded into the split region 401.

Likewise, the indices of split images that should be embedded into split regions 402 to 409 correspond to the entries 362 to 369 of the biometric registration information 360, that is, indices 9, 10, 8, 11, 12, 6, 13, and 14 of the split images. Thus, the corresponding split images are retrieved from the split-image table 105-12 and are embedded into the split regions 402 to 409. Accordingly, the biometric registration information 360 composed of the list of index numbers is converted into the corresponding composite image data 708.

Then, an image comparison unit 706 performs pattern matching between the biometric image data 707 of the individual to be authenticated, which has been entered from the biometric image entry unit 702, and the composite image data 708 created through a combining process as described above, and calculates a quantified degree of similarity.

Exemplary methods for calculating the degree of similarity through pattern matching include a method that involves tracing all pixels, counting the number of pixels N that are located in the same position and have the same value, determining the ratio of the number of pixels N to the total number of pixels A, and evaluating images with a ratio that is closer to as being “similar.” However, any methods can be used as long as the degree of similarity can be quantified. Herein, values of “0 to 1” are used to represent the degree of similarity, and a value that is closer to “1” is regarded as being more similar.

Further, the image comparison unit 706 compares the thus determined degree of similarity with a threshold P, and determines, if the degree of similarity is higher than the threshold P,the authentication to be successful; otherwise, it determines the authentication to be unsuccessful.

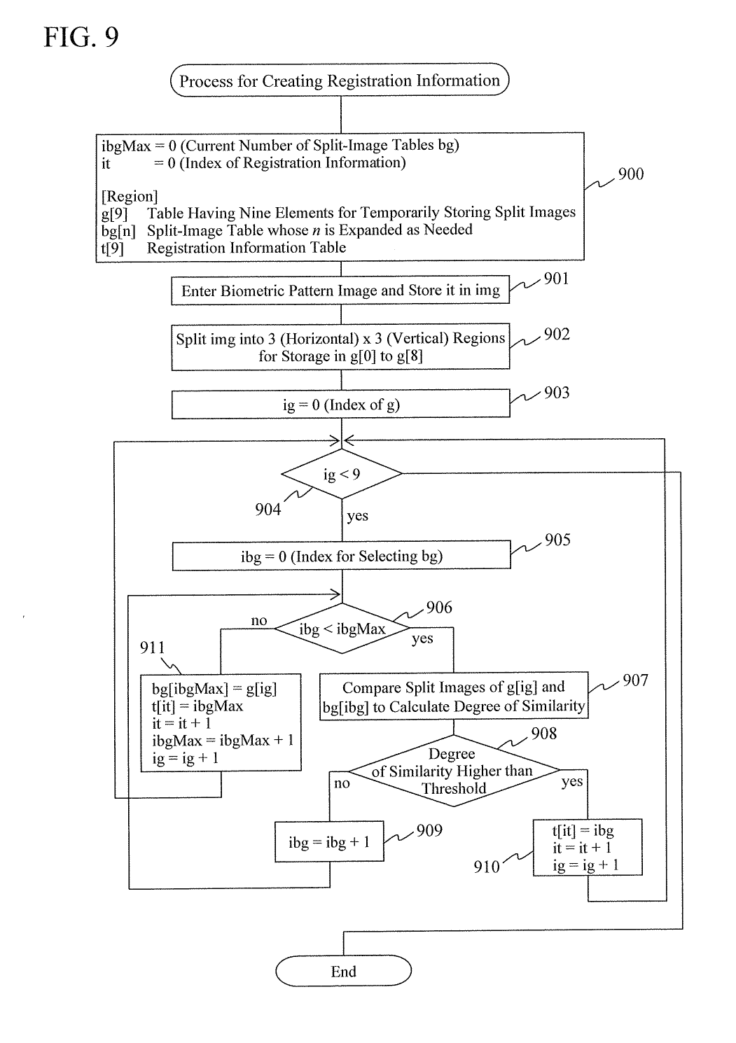

FIG. 9 is a flowchart for creating biometric information using the biometric information creation device in accordance with the present invention. In this flowchart, an image is split into three (horizontal) x three (vertical) regions. First, an initialization process is performed in step 900.

In the initialization process, each of the number ibgMax of the split-image tables bg and the index “it” of the registration information is initialized to “0.” In addition, a table g{9} having nine elements for temporarily storing split images, a split-image table bg{n}, and a biometric registration information table t{9} are provided in memory (not shown).

In step 901, a biometric pattern image for creating registration data is entered and stored in an image region img.

In step 902, the image stored in the img is split into three (vertical) x three (horizontal)regions to create a total of nine split images, and then, the split images are stored in the table g{9} having nine elements “g”.

In step 903, an index “ig” for referring to the table g{9} is initialized to ig=0.

In step 904, if all of the elements in the table g{9} have been listed is determined.

In step 905, an index “ibg” used to list the elements in the split-image table bg{n} is initialized to ibg=0.

In step 906, if all of the elements in the split-image table bg{n} have been listed is determined.

In step 907, the ibg-th element (split image) in the split-image table bg{n} is compared with the ig-th element (entered image) in the table g to calculate the degree of similarity. Herein, elements with a higher degree of similarity are determined to be more “similar” to each other.

In step 908, the degree of similarity calculated in step 907 is compared with a threshold that serves as a basis for judging similarity. If the degree of similarity is higher than the threshold, the elements are determined to be “similar” to each other.

A process in step 909 is performed when the elements are determined to be “not similar” to each other in step 908. Specifically, the index “ibg” for retrieving the next element in the split-image table bg{n} is incremented.

A process in step 910 is performed when the elements are determined to be “similar” to each other in step 908. Specifically, the it-th element in the registration information table t is set at the value of the index “ibg” in the split-image table bg{n}, and the index “it” is incremented to select the next element in the registration information table t, and further, the index “ig” is also incremented to select the next element in the table g{9}.

A process in step 911 is performed when all of the elements in the split-image table bg{n} have been listed in step 906. In this case, as it has been clarified that the split-image table bg{n} contains no elements similar to the split image g{ig}, the split image g{ig} is stored as the igbMax-th element in the split-image table bg, and igbMax is stored as the it-th element in the registration information table t. Further, the “it” is incremented to represent the next element in the registration information table t, and the “ibg” is incremented to represent the next element in the split-image table bg{n}, and further, the “ig” is incremented to represent the next element in the split image g.

As described above, the registration information table t, which is the storage area for the created biometric information, and the split-image table bg, which corresponds to the split-image table, are created. Although such tables are collectively stored in a file or the like, any methods can be used.

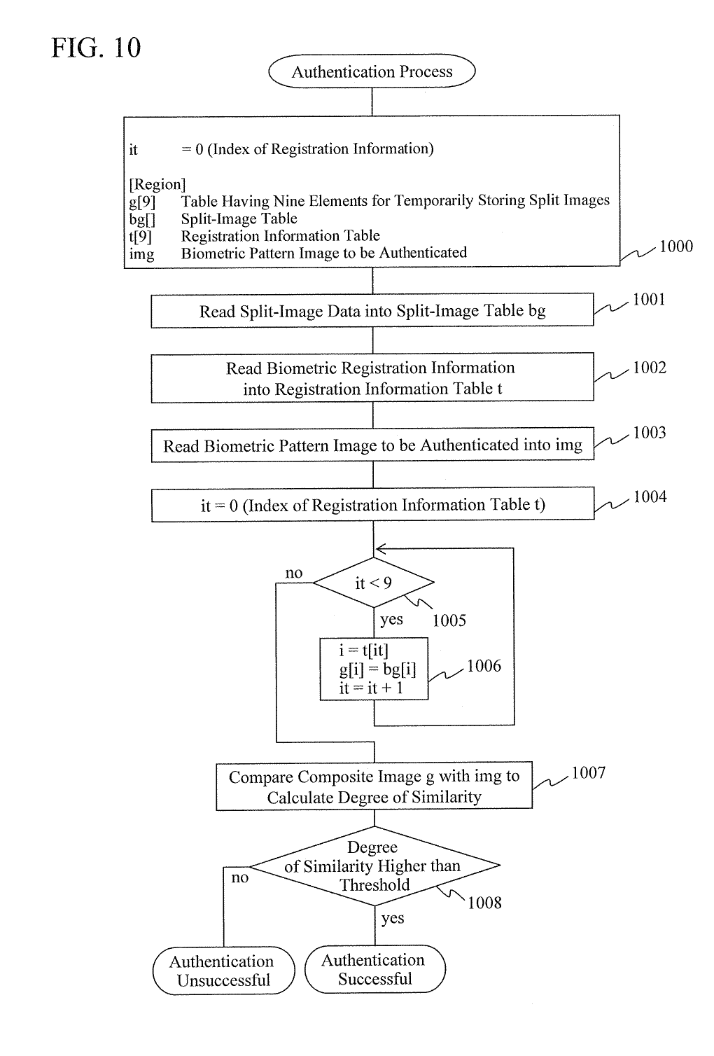

FIG. 10 is a flowchart for performing authentication using the biometric information created with the present invention. In this flowchart, an image is split into 3 (horizontal)×3 (vertical) regions.

Step 1000 is an initialization process in which the index “it” for referring to the registration information table t is initialized.

In step 1001, the split-image data created in the flowchart of FIG. 9 is read into the split-image table bg.

In step 1002, biometric registration information is read into the registration information table t created in the flowchart in FIG. 9.

In step 1003, a biometric pattern image of a living body to be authenticated is read into the img.

In step 1004, the index “it” for listing the elements in the registration information table t is initialized.

In step 1005, if all of the elements in the registration information table t have been listed is determined.

In step 1006, the it-th element in the registration information table t (index of the split-image table gb) is retrieved, so that a split image is retrieved from the split-image table bg, and it is written to the split image g{ig}. Further, in order to represent the next element in the registration information table t, the “it” is incremented.

Step 1007 is executed when all of the elements in the registration information table t have been listed. Specifically, a composite image g created from the registration information table t and the split-image table bg is compared with the biometric pattern image img entered for authentication purposes to calculate the degree of similarity. Herein, images with a higher degree of similarity are determined to be more “similar” to each other.

In step 1008, the degree of similarity calculated in step 1007 is compared with a threshold that serves as a basis for judging similarity. If the degree of similarity is higher than the threshold, the images are determined to be “similar” to each other and thus the authentication is determined to be successful; otherwise, the elements are determined to be “not similar” to each other and thus the authentication is determined to be unsuccessful.

In this embodiment, split images indicated by index numbers are combined into a single composite image, and the composite image is compared with a biometric pattern image entered from the biometric image entry unit 702. However, the combining process can be omitted and split images indicated by index numbers can be sequentially retrieved so that the retrieved split images are sequentially compared with the images obtained by splitting an entered biometric pattern image to thereby determine the degree of similarity and determine if the authentication is successful or not from the overall degree of similarity.

### REFERENCE SIGNS LIST

101 Control Unit
102 Entry Unit
103 Table Update Unit
104 Biometric Information Creation Unit
105 Split-Image Table
107 Split-Image Comparison Unit
108 Biometric Information Storage Area
701 Control Unit
702 Biometric Image Entry Unit
703 Biometric Registration Information Entry Unit
704 Split-Image Table
705 Registration Image Combining Unit
706 Image Comparison Unit
708 Composite Image Data
105-1 to 105-9-6 Split-Image Table

1. A method for creating biometric information, comprising the following steps executed by a biometric information creation device:
a first step of reading a pattern image of a living body and splitting the pattern image into a plurality of regions on a two-dimensional plane;
a second step of assigning index numbers to the respective split-pattern images and storing in a split-image table the split-pattern images with the index numbers assigned thereto;
a third step of splitting a pattern image newly read from a living body into a plurality of regions on a two-dimensional plane and comparing each of the split-pattern images with the split-pattern images stored in the split-image table;
a fourth step of acquiring, if the split-image table is determined to have stored therein a split-pattern image that is similar to one of the split-pattern images of the newly read pattern image as a result of the comparison between the split-pattern images, the index number assigned to the similar split-pattern image;
a fifth step of assigning, if the split-image table is not determined to have stored therein a similar split-pattern image, an index number to the relevant split-pattern image of the newly read pattern image, and storing in the split-image table the relevant split-pattern image with the index number assigned thereto; and
a sixth step of creating, as biometric information that represents a feature of the newly read pattern image of the living body, an index number list composed of the index number acquired in the fourth step and the index number of the split-pattern image stored in the fifth step, and registering the index number list in recording means such as an IC card.

2. A biometric information creation device comprising:
first means for reading a pattern image of a living body, splitting the pattern image into a plurality of regions on a two-dimensional plane, assigning index numbers to the respective split-pattern images, and storing in a split-image table the split-pattern images with the index numbers assigned thereto;
second means for splitting a pattern image newly read from a living body into a plurality of regions on a two-dimensional plane, comparing each of the split-pattern images with the split-pattern images stored in the split-image table, acquiring, if the split-image table is determined to have stored therein a split-pattern image that is similar to one of the split-pattern images of the newly read pattern image as a result of the comparison, the index number assigned to the similar split-pattern image, assigning, if the split-image table is not determined to have stored therein a similar split-pattern image, an index number to the relevant split-pattern image of the newly read pattern image, and storing in the split-image table the relevant split-pattern image with the index number assigned thereto; and
third means for creating, as biometric information that represents a feature of the newly read pattern image of the living body, an index number list composed of the index number acquired when the split-image table has stored therein a similar split-pattern image and the index number assigned to the relevant split-pattern image of the newly read pattern image when the split-image table does not have stored therein a similar split-pattern image, and registering the index number list in recording means such as an IC card.

3. An individual authentication method comprising:
a first step of splitting a pattern image read from a living body into a plurality of regions on a two-dimensional plane, assigning index numbers to the respective split-pattern images, storing in a split-image table the split-pattern images with the index numbers assigned thereto, splitting, each time a new pattern image is read from a living body, the read pattern image of the living body into a plurality of regions on a two-dimensional plane, and assigning, if the split-image table is not determined to have stored therein a split-pattern image that is similar to one of the split-pattern images of the newly read pattern image, an index number to the relevant split-pattern image of the newly read pattern image, and storing in the split-image table the relevant split-pattern image with the index number assigned thereto;
a second step of reading an index number list of split-pattern images in the split-image table that is recorded in a recording medium presented by an individual to be authenticated, acquiring from the split-image table a plurality of split-pattern images indicated by the index number list, and combining the acquired split-pattern images into a single composite pattern image; and
a third step of reading a biometric pattern image of the individual to be authenticated, matching the pattern image to the composite pattern image through pattern matching, and, if the match succeeds, authenticating the individual who has presented the recording medium.

4. The individual authentication method according to claim 3, wherein the index number list read from the recording medium in the second step is obtained by recording an index number list in the recording medium in advance with a biometric information creation device, the index number list being composed the index number, which is acquired when the split-image table has stored therein a split-pattern image that is similar to one of the split-pattern images obtained by splitting the biometric pattern image acquired from the individual to be authenticated into a plurality of regions on a two-dimensional plane, and the index number of the split-pattern image newly stored in the split-image table.

5. An individual authentication device comprising:
a split-image table adapted to have stored therein split-pattern images obtained by splitting a pattern image read from a living body into a plurality of regions on a two dimensional plane and index numbers assigned thereto, and adapted to have stored therein, each time a new pattern image is read from a living body and is split into a plurality of regions on a two-dimensional plane, if the split-image table does not have stored therein a split-pattern image that is similar to one of the split-pattern images of the newly read pattern image, the relevant split-pattern image of the newly read pattern image and an index number assigned thereto;
means for reading an index number list of split-pattern images in the split-image table that is recorded in a recording medium presented by an individual to be authenticated, acquiring from the split-image table a plurality of split-pattern images indicated by the index number list, and combining the acquired split-pattern images into a single composite pattern image;and
means for reading a biometric pattern image of the individual to be authenticated, matching the pattern image to the composite pattern image through pattern matching, and, if the match succeeds, authenticating the individual who has presented the recording medium.

6. The individual authentication device according to claim 5, wherein the index number list read from the recording medium presented by the individual to be authenticated is obtained by recording an index number list in the recording medium in advance with a biometric information creation device, the index number list being composed the index number, which is acquired when the split-image table has stored therein a split-pattern image that is similar to one of the split-pattern images obtained by splitting the biometric pattern image acquired from the individual to be authenticated into a plurality of regions on a two-dimensional plane, and the index number of the split-pattern image newly stored in the split-image table.
